(19) United States
(12) Patent Application Publication
(10) Pub. No.: US 2009/0153750 A1
(43) Pub. Date: Jun. 18, 2009

(54) Image display apparatus

(75) Inventor: Kenji Tsunashima, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 12/285,456

(22) Filed: Oct. 6, 2008

(30) Foreign Application Priority Data
Dec. 17, 2007 (JP) JP2007-324433

(51) Int. Cl. H04N 9/31

(52) U.S. Cl. 348/744; 348/E09.025

(57) ABSTRACT

A projector can be connected to a PC through a network. A flash memory in the projector stores a control program and external storage access information indicating an area in an HDD of the PC where a program for implementing an image display function is stored. During start-up, the projector uses the information stored in the flash memory to execute the program for implementing the image display function, under the control of a CPU. That is, the CPU executes the control program to establish network connection with the PC, then references the external storage access information to access a previously assigned area in the HDD of the PC, and reads the program for implementing the image display function to execute it.

### BACKGROUND OF THE INVENTION

1. Field of the Invention

The present invention relates to an image display apparatus which displays images in response to receipt of data to be subjected to image processing (hereinafter referred to as “image processing-target data”), from a personal computer or the like connected through a network.

2. Description of the Background Art

When a presentation is made with a display screen image, which is being displayed on a monitor of a personal computer (PC) or the like, displayed on an image display apparatus such as a projector, it is conventionally a common practice that a cable is connected to transmit RGB analog signals and the like outputted from the monitor of the PC. For this reason, the projector and the PC have to be disposed close to each other. Also, since the projector and the PC have to be connected on a one-by-one basis, the cable has to be changed in order to use another PC.

With the recent spread of computer networks such as Ethernet (registered trademark), e.g., a method of displaying presentation data and the like that are transmitted over a network has come into use. According to the method, the projector and the PC can be disposed in any desired positional relationship as long as they are within an area where network connection can be established, and therefore, a system can be configured without cable connection by, e.g., introduction of a wireless LAN. Moreover, one projector can be accessed from any PC connected through the network.

According to a system described in Japanese Patent Application Laid-Open No. 2002-366341 (see FIG. 1), for example, contents to be displayed are sent in the form of draw commands, so that image processing-target data is transmitted to a projector from a PC over a network while reducing network traffics (information that runs a particular path of a network during a predetermined period of time).

In addition, Japanese Patent Application Laid-Open No. 2005-284195 (see FIG. 3) discloses a method based on bitmap transfer called VNC (Virtual Network Computing) where image processing-target data defining a display screen image of a PC is sent to a projector.

Further, Japanese Patent Application Laid-Open No. 2000-23150 (see FIG. 1) describes that image data, together with image control data, is sent from a server over a network so as to perform necessary processing for display as appropriate according to the image data, thereby improving convenience of the network connection.

The foregoing background techniques make it possible to reduce traffics while a network is connected and to diversify data formats of images that are capable of being displayed. Japanese Patent Application Laid-Open Nos. 2002-366341 and 2005-284195 propose improvement in method of transmitting image processing-target data from a PC to a projector. A network is introduced not just to deliver data defining a display screen image of a PC to a projector but also for expanding functions of the projector by sending control data as described in Japanese Patent Application Laid-Open No. 2000-23150. That is, the foregoing three background techniques are all based on the transmission of a variety of image processing-target data (presentation data) to the projector serving as an image display apparatus from the PC.

In cases where a presentation and the like are made with an image display apparatus such as a projector connected to a PC through a network in the above-described manner, it is necessary to incorporate a microprocessor in the image display apparatus such as a projector so as to implement the function to establish network connection and the function to display images (the function to generate a display screen image) corresponding to a variety of image processing-target data. That is, in order to implement the above-described functions in the image display apparatus, it is necessary to have various programs stored therein and to cause the microprocessor to execute the programs.

As such, in order to handle a variety of presentation data in a network-based image transmission and display system including an image display apparatus and a PC, the image display apparatus inevitably develops problems of increase in processing load on the incorporated microprocessor, increase in memory size for storing programs for the function to generate display screen images, and reduction in display speed.

### SUMMARY OF THE INVENTION

It is an object of the present invention to handle a variety of image processing-target data and simultaneously to reduce processing loads, decrease memory sizes, and improve display speeds in an image display apparatus that is connectable to a PC and the like through a network.

An image display apparatus according to the present invention is an image display apparatus connectable to a predetermined computer through a network. The predetermined computer includes an external storage unit storing in a first area a first program for implementing an image display function, which first program corresponds to first image processing-target data.

The image display apparatus includes an interface for network connection, an internal storage unit, an image processing unit, and a display device.

The internal storage unit holds external storage access information containing information relating to the first area for the first program for implementing the image display function. The image processing unit confirms during start-up establishment of network connection with the predetermined computer through the interface, and then reads the first program for implementing the image display function from the external storage unit of the predetermined computer based on the external storage access information acquired from the internal storage unit and executes that first program, whereby first image display processing is performed on the first image processing-target data to obtain display data. The display device displays an image based on the display data.

The image display apparatus advantageously allows image processing corresponding to various image processing-target data to be performed without increasing the complexity of internal configuration, by appropriately altering the contents of the first program for implementing the image display function stored in the external storage unit of the predetermined computer.

In addition, since the first program for implementing the image display function itself is stored in the external storage unit of the predetermined computer, the internal memory size can be reduced, as there is no need to store the first program for implementing the image display function in the image display apparatus.

Moreover, the processes of generating the first image processing-target data are performed by an external apparatus including the predetermined computer, and it is sufficient that the image display apparatus carries out the first image display processing; therefore, high-speed processing advantageously becomes possible without increasing processing loads on the image display apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an environment for a network-based image transmission and display system including a projector according to a first embodiment of the present invention;

FIG. 2 is an illustration showing another aspect of the projector according to the first embodiment;

FIG. 3 is an illustration showing a specific example of the way the projector of the first embodiment uses a program for implementing an image display function stored in a PC;

FIG. 4 is an illustration of a specific example in a case where the VNC is implemented in the projector of the first embodiment; and

FIG. 5 is a block diagram showing an environment for a network-based image transmission and display system including a projector according to a second embodiment of the present invention.

### DESCRIPTION OF THE PREFERRED EMBODIMENTS

### First Embodiment

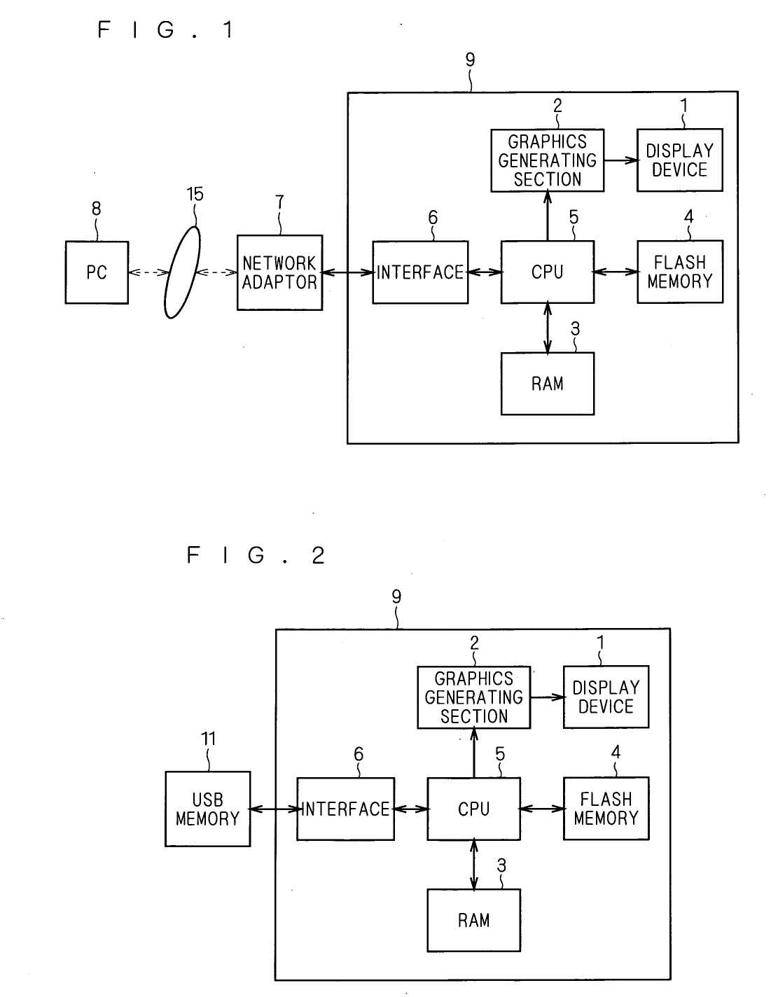

FIG. 1 is a block diagram showing an environment for a network-based image transmission and display system including a projector 9 according to a first embodiment of the present invention. As shown in the figure, the projector 9 serving as an image display apparatus is connectable to a PC 8 through a network adaptor 7 and a network 15.

The projector 9 includes therein a display device 1, a graphics generating section 2, a RAM 3, a flash memory 4, a CPU 5, and an interface 6.

The display device 1 performs graphics display processing on the basis of display data generated in the graphics generating section 2 to display an image. The graphics generating section 2 is controlled by a built-in microprocessor (CPU) 5, performs image display processing on image processing-target data, and generates display data capable of being displayed on the display device 1. The graphics generating section 2 and the CPU 5 function as an image processing unit.

The flash memory 4 serving as an internal storage unit of the projector 9 stores a basic control program that has been prepared previously and external storage access information that indicates an area (a first area) in an external storage unit such as an HDD of an external PC, in which area a program for implementing an image display function is stored.

The CPU 5 is connected to the flash memory 4, the RAM 3, and the interface 6 such that bidirectional data transmission can be performed therebetween. The RAM 3 is required as a working area and the like when a program is executed, and the interface 6 is used in data transmission/reception with an external apparatus.

In the present embodiment, the interface 6 is connected with the network adaptor 7, so that network connection by way of the network 15 with the PC 8, which is used as a file server, can be established.

Generally, the display device 1, the graphics generating section 2, the RAM 3, the flash memory 4, the CPU 5, and the interface 6 are contained in one housing, in an actual apparatus configuration of the projector 9. Also, the network adaptor 7 is generally provided outside the housing.

In the following description, it is assumed that a USB interface is used as the interface 6 and that a USB wireless LAN adaptor is used as the network adaptor 7.

A description is given below on settings for an image display function that are made under the control of the CPU 5.

(1) First, the projector 9 is powered on, and the CPU 5 reads the control program from the flash memory 4 to execute the program and to make necessary initial settings within the projector 9.

(2) Subsequently, while continuously executing the control program, the CPU 5 determines whether or not the network adaptor 7 is connected to the interface 6. When determining that the network adaptor 7 is connected, the CPU 5 checks whether it is possible to communicate with the PC 8 (a PC capable of implementing an image display function) that can supply program files and the like for implementing an image display function. When it is confirmed that the network connection is established with the PC capable of implementing the image display function, the next processing (3) is performed.

If the PC 8 is a PC capable of implementing an image display function, a portion of a hard disk drive (an HDD) of the PC 8 is assigned in advance to the projector connected through the network. That is, the HDD of the PC 8 stores program files and the like for implementing the image display function (hereinafter sometimes simply referred to as a “program for implementing an image display function”) and also is set such that the projector 9 can access the program for implementing the image display function, over a LAN.

(3) The CPU 5 continuously executes the control program, accesses the previously assigned area (the first area) in the HDD of the PC 8, and reads and executes the program for implementing the image display function that exists in the accessed area. It should be noted that the CPU 5 recognizes the previously assigned area in the HDD of the PC 8 by referring to the external storage access information in the flash memory 4 at any of the occasions where (1), (2), or (3) occurs.

As a system for accessing a storage device (an HDD and the like) in another external apparatus over a LAN, it is possible to use, e.g., the NFS (Network File system) that is commonly and widely used nowadays in network environments. The CPU 5 sets that Linux be booted as an OS (Operating System) after the initial setting and makes the program for implementing the image display function in the PC 8 accessible using the NFS.

In this manner, the communication between the projector 9 and the PC 8 that are connected through the network 15 is established through the NFS, at which time the previously defined storage area in the HDD of the PC 8 becomes accessible for the projector 9, like the storage area in the HDD incorporated in the projector 9 itself.

The above processing from (1) to (3) is detailed, taking a case in which Linux is run as an example.

(1) In order to run Linux and to make the program for implementing the image display function in the PC 8 executable, required are a kernel, which is the body of the Linux OS, and a root filesystem that is loaded with various configuration files and the program for implementing the image display function. In the first embodiment, the kernel is stored in the flash memory 4 in a compressed form as the above-mentioned control program. The kernel is read during the system start-up to perform initial setting operation for booting Linux.

(2) On the booted Linux, it is first verified whether communication is possible with the PC capable of implementing the image display function, and if possible, LAN connection is established with the PC 8 serving as the PC capable of implementing the image display function.

(3) Subsequently, the area in the HDD of the PC 8 where the root filesystem is stored is accessed so that the NFS root filesystem is made available for the projector 9. For example, in the case where the position in the root filesystem where the program for implementing the image display function is stored has been previously decided on Linux, the projector 9 acquires the root filesystem in the HDD of the PC 8, whereupon the projector 9 can access the program for implementing the image display function. In this case, the flash memory 4 holds the external storage access information indicating the root filesystem storage area in the HDD of the PC 8. That is, the external storage access information indicates the area where the root filesystem is stored, which area is in the HDD of the PC 8, as the information relating to the storage area of the program for implementing the image display function.

Consequently, the projector 9 becomes accessible to the program for implementing the image display function that has been previously assigned in the root filesystem on the PC 8, as well as to the area in the HDD incorporated in the projector 9 itself, therefore, the projector 9 can execute the program for implementing the image display function stored in the HDD of the PC 8 without the need of downloading it.

Although a wireless LAN adaptor is used as the network adaptor 7 for the network connection so as to eliminate the need of providing a cable between the PC 8 and the projector 9, a general LAN adaptor may be used as the network adaptor 7 to establish connection with the PC 8 by means of a cable, in which case also, the operation can be performed likewise.

It should be noted that it is possible to store in the flash memory 4 the root filesystem on which a limited amount of files are loaded so as to keep the size compact, and to use that root filesystem stored in the flash memory 4 as a substitute in cases where the network adaptor 7 is not connected to the interface 6 or in cases where an available root filesystem is not found in the PC capable of implementing the image display function.

That is, when it is not possible for some reason to execute the program for implementing the image display function stored in the HDD of the PC 8, the projector 9 can launch the system using the root filesystem stored in the flash memory 4 and perform limited kinds of image display processing (second image display processing) such as displaying of video signals from a VGA input.

In this case, a first simplified display program (a second program for implementing an image display function) for displaying the video signals from the VGA input (second image processing-target data) is assigned in the root filesystem in the flash memory 4 and stored there in advance, and the first simplified display program is read and executed, so that the above processing can be performed.

In this manner, even when the program for implementing the image display function stored in the HDD of the PC 8 is unable to be executed, the first simplified display program is read from the flash memory 4 and executed, whereby the projector 9 of the first embodiment can carry out the image processing operation independently.

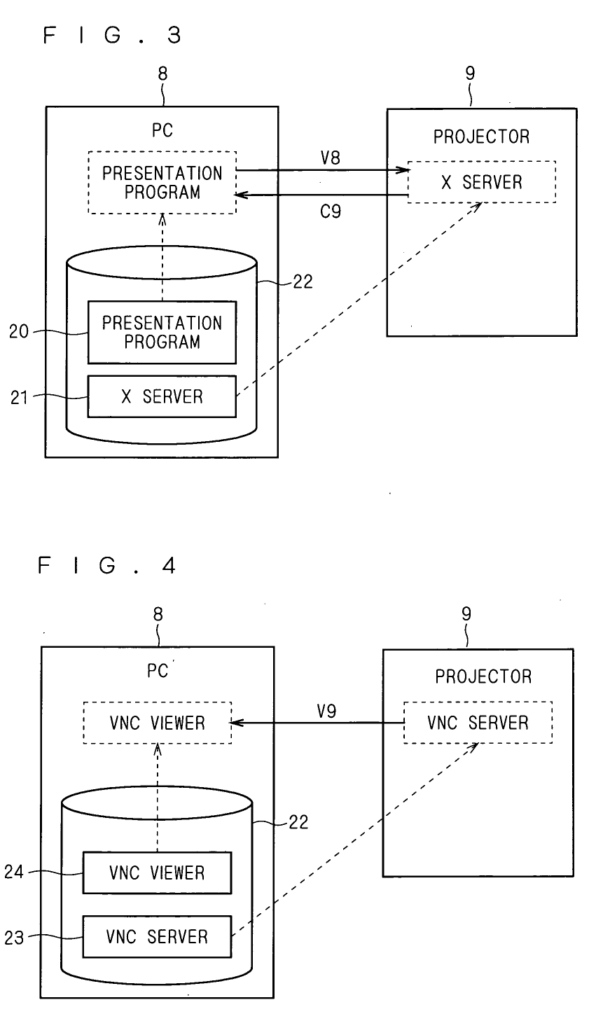

As shown in FIG. 2, it is also possible to configure, in the case where the CPU 5 detects that the interface 6 is connected with a USB memory 11 (a predetermined external storage device) such as a flash memory instead of the network adaptor 7, such that the contents of the files stored in the USB memory 11 are searched, and when one equivalent to the root filesystem of the USB memory 11 is located, to use the root filesystem of the USB memory 11 just as over the LAN connection.

In this case, the above processing can be performed by assigning in the root filesystem a second simplified display program for predetermined image processing-target data (third image processing-target data) and storing the program in advance in the USB memory 11, and by reading and executing the second simplified display program.

In this manner, even when the program for implementing the image display function stored in the HDD of the PC 8 is unable to be executed, the projector 9 of the first embodiment can carry out the image processing operation with the use of an external storage device (the USB memory 11) that is capable of being connected directly to the projector 9, by executing the second simplified display program read from the USB memory 11.

FIG. 3 is an illustration showing a specific example of the way the projector 9 of the first embodiment uses the program for implementing the image display function in the PC 8. As shown in the figure, the PC 8 has a built-in hard disk drive (HDD) 22 storing a presentation program 20 and an X server (program) 21. The presentation program 20 is executed on the PC 8, and the X server 21 is executed on the projector 9.

Various forms may be possible to transmit data stored in the HDD 22 of the PC 8 to be provided for screen display. For example, consider a case in which graphic display software called “X Window System” is used. The software is configured with an X server and an X client. The X server serves to display a screen and to directly process inputs from a keyboard and a mouse, on the computer on which the X server is executed. The X client generates graphics data such as a user interface to be displayed on the X server screen. The communication between the X client and X server is established through a method called X protocol. The X client and the X server may be on the same machine, or may be separately provided on different machines. In the example shown in FIG. 3, the X server 21 which is loaded in the root filesystem in the HDD 22 of the PC 8 is executed as the program for implementing the image display function by using the CPU 5 in the projector.

That is, the projector 9 reads from the flash memory 4 the external storage access information indicating the storage area of the X server 21 and performs the above-described processing from (1) to (3). As a result, the projector 9 becomes accessible to the HDD 22 of the PC 8 as well as to the area in the HDD incorporated in the projector 9 itself, so that the projector 9 can read and execute the X server 21 stored in the HDD 22 of the PC 8 without the need of downloading the X server 21.

Meanwhile, an application program (the presentation program 20 in FIG. 3) to serve as the X client is executed on the PC 8, and image data V8, which is (first) image processing-target data defining the display screen images, is sent to the CPU 5 in the projector 9 according to the X protocol.

The graphics generating section 2 performs (first) image display processing on the image data V8 that has been sent according to the X protocol, to generate display data and sends the display data to the display device 1. At this point, the processing at the graphics generating section 2 is carried out through the execution of the X server 21 under the control of the CPU 5.

As described above, in the projector 9 of the first embodiment, since it is sufficient for the flash memory 4 to store the above-described control program and the external storage access information, the flash memory 4 does not have to store a program for implementing an image display function corresponding to image processing-target data; the reason therefor is that it suffices that such a program exists externally as a program assigned in the root filesystem of the HDD of the PC 8. Consequently, the projector 9 can be reduced in its internal memory size.

Moreover, the image processing-target data (the presentation data) is created by means of the presentation program 20 that runs on the PC 8; therefore, if the format of the image processing-target data to be transmitted from the PC 8 is changed, a program for implementing an image display function that corresponds to the image processing-target data in the changed format may be read from the HDD of the PC 8.

As a result, the projector 9 of the first embodiment can execute programs for implementing image display functions that correspond to image processing-target data in various formats without increasing the internal memory size. That is, the projector 9 advantageously becomes capable of performing image processing corresponding to a variety of image processing-target data without increasing complexity of the internal configuration.

Further, since the processes of generating image processing-target data by means of the presentation program and the like are conducted in the PC 8, loads on the CPU 5 of the projector 9 can be reduced, and the projector 9 is expected to be enhanced in processing speed in image display processing. In addition, the absolute amount of data (the image data V8) that is transmitted from the PC 8 to the projector 9 can be reduced, and thus the processing can be carried out at a sufficiently high speed even when the image display processing that the projector 9 performs is taken into account.

With the software configuration shown in FIG. 3, it should be noted that, when there is an item to be operated in the user interface screen of the presentation program 20 running on the PC 8, the operation of the program is conducted via an input device (not shown) connected to the microprocessor incorporated in the projector. As a device for inputting data to the projector, a remote control and the like can be used, and it is only necessary to set such that signals from the remote control can be used as the input for the X server 21. In this case, control signals C9 are sent from the X server 21 that is executed on the projector 9 to the presentation program 20 in the PC 8.

It is also possible to configure that the presentation program 20 can be operated using an input device such as a keyboard and a mouse of the PC 8 while viewing the display screen image of the projector 9 on (the monitor connected to) the PC 8. In order to easily implement this configuration, it is possible to use software called VNC (Virtual Network Computing), which is detailed in the foregoing Japanese Patent Application Laid-Open No. 2005-284195.

With the VNC, the image data V9, which is bitmap data of the graphics screen image that is being displayed on the projector 9, can be transmitted to the PC 8 over the network, so that the data V9 is written into a buffer for graphics display in the PC 8, i.e., on the receiver side. As a result, the display screen image of the projector 9, i.e., a machine to serve as a server, can be displayed on the screen of the PC 8, i.e., a client machine, and also the input device such as a keyboard and a mouse of the client machine can be used as the input device for the machine to serve as a server.

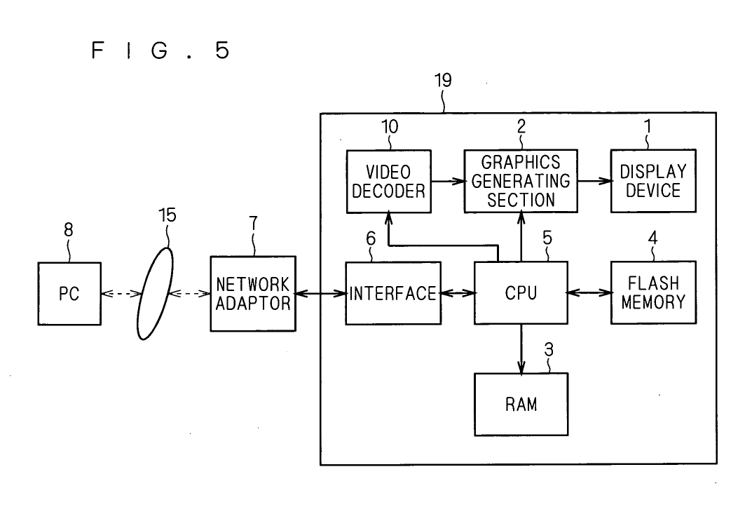

FIG. 4 is an illustration showing the software configuration in the case of using the VNC in the network-based image transmission and display system shown in FIG. 1. As shown in the figure, the PC 8 stores a VNC server (program) 23 (a program for externally outputting image signals) and a VNC viewer (program) 24 in the HDD 22. Note that the software configuration shown in FIG. 3 is simultaneously implemented.

The projector 9 can read the VNC server 23 from the HDD 22 and execute it in the same manner as with the X server 21 in FIG. 3. The VNC server 23 can be read, provided that external storage access information indicating a storage area (a second area) of the VNC server 23 in the HDD 22 is held in the flash memory 4, as in the case of the X server 21.

As a result, the projector 9 executes the VNC server 23, whereby image data V9 (image data for external output), which is bitmap data defining the display screen image that is being displayed on the display device 1 of the projector 9, can be transmitted to the PC 8 over the network.

Meanwhile, the VNC viewer 24 is executed on the PC 8 like the presentation program 20 in FIG. 3. As a result, the VNC viewer 24 is executed based on the image data V9 acquired from the projector 9, thereby allowing the display screen image of the projector 9 to be displayed on the screen of the PC 8, i.e., the client machine.

The keyboard and the mouse provided to the PC 8 are then operated to execute the presentation program 20 shown in FIG. 3, whereby presentation software can be controlled while confirming, on the side of the PC 8, the contents of the screen image that is being displayed on the projector 9.

As described above, the projector 9 of the first embodiment reads the VNC server 23 serving as the program for externally outputting image signals and executes the VNC server 23 to externally output the image data V9, i.e., the image data for external output, so that the display screen image of the projector 9 can be referenced from an external apparatus such as the PC 8.

### Second Embodiment

FIG. 5 is a block diagram showing the configuration of a network-based image transmission and display system including a projector 19 according to a second embodiment. As shown in the figure, the projector 19 includes a video decoder 10 in addition to the internal configuration of the projector 9 of the first embodiment.

As described in connection with the projector 9 of the first embodiment, an output screen image of the presentation program executed on the PC 8 is displayed on the screen of the projector 9. At this point, because in the first embodiment, the image data V8 defining the display screen image is transmitted from the PC 8 to the X server 21 of the projector 9 according to the X protocol, processing other than displaying is usually performed in the PC 8.

The projector 9 of the first embodiment is therefore suitable for transmission of stationary graphics screen images; however, in the case where the projector 9 of the first embodiment displays motion pictures, e.g., motion picture signals compressed according to an MPEG standard (e.g., MPEG-2), the signals may be decoded in the PC 8 and then transmitted to the projector 9, which however causes increased loads during display processing and the like in view of increase in transmission band, with the result that motion pictures that are capable of being displayed on the real-time basis are limited in size.

In view of the above, the projector 19 of the second embodiment implements the configuration where motion picture streams including compressed video signals are transmitted from the PC 8 to the projector 19, and the video decoder 10 mounted in the projector 19 decodes the motion picture streams to obtain decoded video signals. The motion picture streams are supplied over the network 15, received in the projector 19 by way of the network adaptor 7 and the interface 6, and provided to the video decoder 10 under the control of the CPU 5.

In the projector 19, final display data is obtained through superimposition of the above-mentioned decoded video signals on intermediate display data (corresponding to the display data of the projector 9 according to the first embodiment) that has been acquired as needed by the image display processing at the graphics generating section 2. The final display data is supplied to the display device 1 from the graphics generating section 2 to display the display screen image at the display device 1. That is, the graphics generating section 2 can perform image display processing involving the decoded video signals to output the display data.

At this point, the motion picture streams are stored in the PC 8. In order to transmit the motion picture streams from the PC 8 to the projector 19, the CPU 5 effects remote mount of the area in the HDD where the streams are stored through the above-described NFS, and then a selected motion picture stream is read from that area and is supplied to the decoder 10, whereby the motion picture processing can easily be carried out.

It is assumed herein that the CPU 5 can control the video decoder 10 and set screen sizes, positions, and the like of the motion pictures. The CPU 5 also controls the graphics generating section 2 at the later stage to create the final display data to be provided to the display device 1, in which final display data the decoded video signals and the intermediate display data are superimposed.

Although in the above example, motion picture files are transmitted from the PC 8 to the projector 19 through the NFS, another network transmission method such as the HTTP (HyperText Transfer Protocol) or the RTP (Real-time Transport Protocol) may be used to transmit compressed video signals from the PC 8 to the projector 19.

According to the method, video signals in a compressed form are transmitted from the PC 8 to the projector 19, which enables efficient use of transmission bands. Also in the projector 19, processes of decoding motion pictures are performed exclusively by the video decoder 10, so that loads during the motion picture processing can be reduced significantly.

As an actual use example, the present invention is generally applicable to image display apparatuses that effect image display by performing image display processing on image processing-target data including motion pictures that are supplied from a PC connected through various networks.

While the invention has been shown and described in detail, the foregoing description is in all aspects illustrative and not restrictive. It is therefore understood that numerous modifications and variations can be devised without departing from the scope of the invention.

What is claimed is:

1. An image display apparatus connectable to a predetermined computer through a network, said predetermined computer including an external storage unit storing in a first area a first program for implementing an image display function, said first program corresponding to first image processing-target data, the image display apparatus comprising:
an interface for network connection;
an internal storage unit holding external storage access information containing information relating to said first area for said first program for implementing the image display function;
an image processing unit that confirms during start-up establishment of network connection with said predetermined computer through said interface, reads from said external storage unit of said predetermined computer and executes said first program for implementing the image display function based on said external storage access information acquired from said internal storage unit, and performs first image display processing on said first image processing-target data to obtain display data; and
a display device that performs image display based on said display data.

2. The image display apparatus according to claim 1, wherein
said internal storage unit further stores a second program for implementing an image display function, said second program corresponding to second image display data, and
when said first program for implementing the image display function is unable to be read during the start-up, said image processing unit executes said second program for implementing the image display function read from said internal storage unit and performs second image display processing on said second image display data.

3. The image display apparatus according to claim 1, wherein said interface is connectable to a predetermined external storage device instead of the network connection, said predetermined external storage device storing a third program for implementing an image display function, said third program corresponding to third image display data, and
when said interface is connected to said predetermined external storage device, said third program for implementing the image display function read from said predetermined external storage device is executed to perform third image display processing on said third image display data.

4. The image display apparatus according to claim 1, wherein
said external storage unit of said predetermined computer stores in a second area a program for externally outputting an image signal, said program being adapted to externally output image data for external output, said image data corresponding to said display data,
said external storage access information further includes information relating to said second area where said program for externally outputting an image signal is stored in said external storage unit, and said image processing unit confirms during start-up establishment of network connection with said predetermined computer through said interface, performs said first image display processing, and reads from said external storage unit of said predetermined computer and executes said program for externally outputting an image signal to externally output said image data for external output.

5. The image display apparatus according to claim 1, further comprising:
a video decoding unit that receives and decodes a compressed video signal to output a decoded video signal, wherein
said image processing unit performs image processing involving said decoded video signal.
